(19) United States
(12) Patent Application Publication
(10) Pub. No.: US 2005/0138572 A1
(43) Pub. Date: Jun. 23, 2005

(54) METHODS AND SYSTEMS FOR ENHANCING RECOGNIZABILITY OF OBJECTS IN A WORKSPACE

(75) Inventors: Lance E. Good, Cupertino, CA (US); Mark J. Stefik, Portola Valley, CA (US)

Correspondence Address: OLIFF & BERRIDGE, PLC., P.O. BOX 19928, ALEXANDRIA, VA, 22320, US

(73) Assignee: PALO ALTO RESEARCH CENTER, INCORPORTED, Palo Alto, CA (US)

(21) Appl. No.: 10/707,532

(22) Filed: Dec. 19, 2003

(51) Int. Cl. G06F 3/00

(52) U.S. Cl. 715/805; 715/790; 715/705; 715/712; 715/711; 715/776; 715/715; 715/708; 715/798

(57) ABSTRACT

Systems and methods for enhancing recognizability of objects/groups in a workspace are provided, wherein the objects/groups are free-format. In an exemplary method, it determines whether a first object/group is moved to a location within a predetermined distance of a second object/group, and a display cue of the second object/group is assigned to the first object/group upon placement of the first object/group in the workspace, whereby the first object/group and the second object/group form a group. In addition, the display cue of the second object/group may be temporarily assigned to the first object/group when the first object/group is moved to a location within the predetermined distance of the second object/group.

### RELATED APPLICATIONS

The following related U.S. patent applications are hereby incorporated herein by reference in their entirety: U.S. patent application Ser. No. 10/371,017, filed Feb. 21, 2003, entitled “System and Method for Interaction of Graphical Objects on a Computer Controlled System”; U.S. patent application Ser. No. 10/371,263, filed Feb. 21, 2003, entitled “System and Method for Moving Graphical Objects on a Computer Controlled System”; U.S. patent application Ser. No. 10/369,613, filed Feb. 21, 2003, entitled “Method and System for Incrementally Changing Text Representation”; U.S. patent application Ser. No. 10/369,614, filed Feb. 21, 2003, entitled “Method and System for Incrementally Changing Text Representation”; U.S. patent application Ser. No. 10/369,612, filed Feb. 21, 2003, entitled “Methods and Systems for Navigating a Workspace”; U.S. patent application Ser. No. 10/369,624, filed Feb. 21, 2003, entitled “Methods and Systems for Interactive Classification of Objects”; and U.S. patent application Ser. No. 10/369,617, filed Feb. 21, 2003, entitled “Methods and Systems for Indicating Invisible Contents of Workspace”.

### BACKGROUND OF THE INVENTION

1. Field of the Invention

This invention relates to methods and systems for enhancing recognizability of objects and groups of objects in a workspace.

2. Description of Related Art

“Sensemaking” is a process of gathering, understanding, and using information for a purpose. A sensemaker gathers information, identifies and extracts portions of the information, organizes such portions for efficient use, and ultimately incorporates the information in a work product with the required logical and rhetorical structure.

Many kinds of information work involve a workspace. A workspace is one large space in which objects, such as text objects and/or other objects, are present at various locations. For example, a workspace may be a two-dimensional workspace in which objects have a defined positional relationship and are represented on a coplanar or substantially coplanar virtual surface that can be scrolled and/or panned on a computer monitor to bring the different places of the surface into view.

FIG. 1 shows an example of a workspace 100 with objects 110. A common part of many sensemaking tasks is organizing units of information into groups. In FIG. 1, a group 120 may be formed of one or more objects 110.

### SUMMARY OF THE INVENTION

Zoomable user interfaces using computers address the problem of sensemaking to an extent by enabling a user to “zoom out” to see a large amount of information at reduced scale, and to “zoom in” to see information in detail. A difficulty in zoomable interfaces is that the display space and number of pixels available per information object are more limited when the view is zoomed out. This causes objects to be less recognizable when viewed in this mode.

Various exemplary techniques according to this invention enhance the activity of informal spatial clustering by providing visual cues of cluster (group) membership and by enhancing the recognizability of groups when they are displayed at reduced or zoomed-out scale.

Various exemplary embodiments of this invention use common display cues to indicate common membership in groups. It should be apparent that various display cues may be used. Various processes may assign display cues at different times, such as when objects are added to the workspace, when objects are added to a group, or when groups are merged together or broken apart. Various exemplary embodiments of this invention also use a zoomable workspace. The workspace may use a free-form layout, in which there may be no requirement to align objects in a structured layout, such as rows and columns. In effect, the user can move items around and cluster them informally. This freedom of layout naturally represents the tentativeness and organic quality of informal clustering.

Accordingly, various exemplary embodiments of this invention provide methods for enhancing recognizability of objects/groups in a workspace, wherein the objects/groups are free-format. In other words, the objects/groups may be any types of format, such as text, graphics and multimedia data. Various exemplary embodiments include determining whether a first object/group is moved to a location within a predetermined distance of a second object/group, and assigning a display cue of the second object/group to the first object/group upon placement of the first object/group in the workspace, whereby the first object/group and the second object/group form a group. In addition, various exemplary embodiments may also include temporarily assigning the display cue of the second object/group to the first object/group when the first object/group is moved to a location within the predetermined distance of the second object/group.

Various exemplary embodiments of this invention provide a system for enhancing recognizability of objects/groups in a workspace, wherein the objects/groups are free-format. Various exemplary embodiments include a display cue assignment circuit that determines whether a first object/group is moved to a location within a predetermined distance of a second object/group, and assigns the display cue of the second object/group to the first object/group upon placement of the first object/group at the location, an object placement circuit that places the at least one first object at a the location, and an object grouping circuit that groups the first object/group and the second object/group when the first object/group is assigned the display cue of the second object/group. In various exemplary embodiments of this invention, the display cue assignment circuit may also temporarily assigns the display cue of the second object/group to the first object/group when the first object/group is moved to a location within the predetermined distance of the second object/group.

### BRIEF DESCRIPTION OF THE DRAWINGS

Various exemplary embodiments of the systems and methods according to this invention will be described in detail, with reference to the following figures, wherein:

FIG. 1 is a diagram illustrating objects in a workspace;

FIG. 2 is a diagram illustrating introduction of a new object into the workspace according to an exemplary embodiment of this invention;

FIG. 3 is a diagram illustrating a preview of a display cue assignment of the new object according to an exemplary embodiment of this invention;

FIG. 4 is a diagram illustrating a highlighted boundary of a group of objects according to an exemplary embodiment of this invention;

FIGS. 5 and 6 are diagrams illustrating display cue assignment and grouping of a new object and an unassigned object according to an exemplary embodiment of this invention;

FIGS. 7 and 8 are diagrams illustrating changes in the display cue assignment when two groups are merged according to an exemplary embodiment of this invention;

FIG. 9 is a flowchart outlining a process of assigning a display cue to a new/moved object according to an exemplary embodiment of this invention;

FIG. 10 is a flowchart outlining a process of indicating a group boundary and including a new/moved object in the group according to an exemplary embodiment of this invention;

FIG. 11 is a flowchart illustrating display cue assignment to groups and merging of groups according to an exemplary embodiment of this invention; and

FIG. 12 is a block diagram of an object recognizability enhancement system according to an exemplary embodiment of this embodiment.

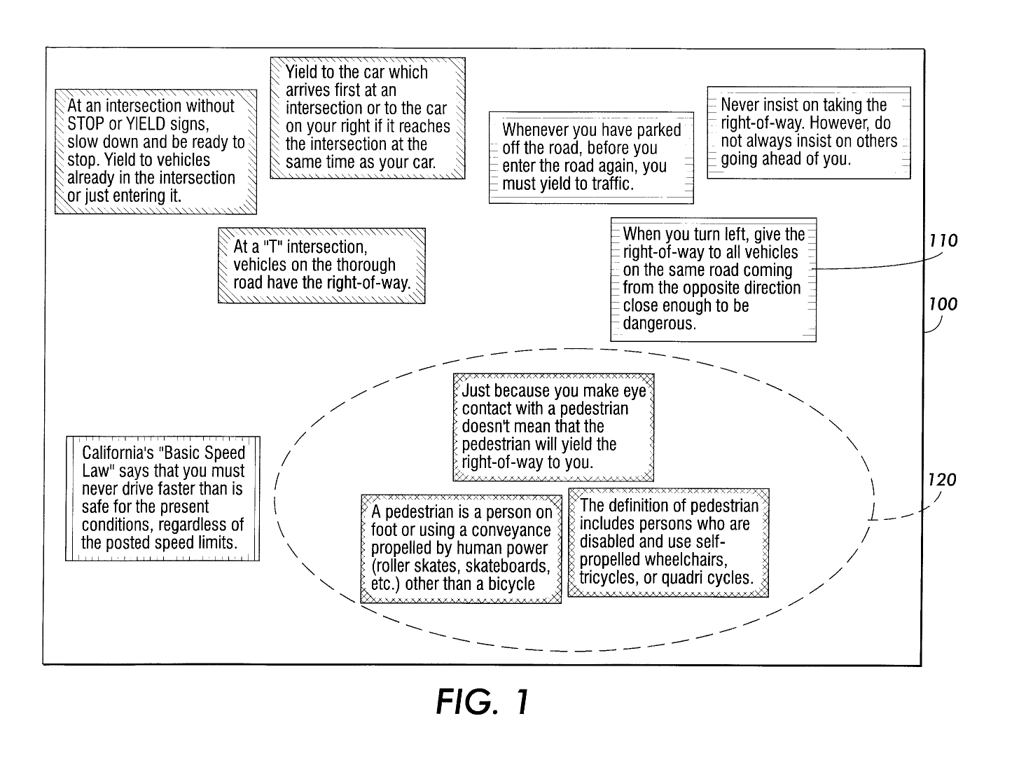

### DETAILED DESCRIPTION OF EXEMPLARY EMBODIMENTS

Various exemplary embodiments of the interactive group indication assignment systems and methods according to this invention provide a way to automatically assign a new and/or moved object with a group indication, such as a color, and may also provide assistance for grouping objects in a workspace. In various exemplary embodiments, the systems and methods according to this invention enhance recognizability of objects in a workspace.

Various aspects of this invention may be incorporated in a system, such as the systems disclosed in the incorporated U.S. patent application Ser. No. 10/371,017, filed Feb. 21, 2003, entitled “System and Method for Interaction of Graphical Objects on A Computer Controlled System,” which is incorporated herein by reference in its entirety.

According to various exemplary embodiments of this invention, common display cues may be used to indicate common membership in groups. Examples of such display cues include, but not limited to, group-specific background color for objects, group-specific color for text of objects, group-specific color for bounding lines for objects, colored halos or containers for objects, colored regions surrounding objects in groups, line pattern boundaries for groups, unique halftone or gray-shade boundaries for objects, common font for text of objects in a group. Light background coloring (e.g. pastel colors) may be used for objects in a group because such a color may provide “low spatial frequency” cues for easy visual comprehension at multiple scales. In the following description, it should be understood that any of various visual membership cues may be used solely or in combination with other types of cues. For the sake of simplicity, only group-specific color assignment is used in the following description. In addition, to indicate a group, a title bar may be used. The title bar may describe the subject of the group.

Moreover, in various exemplary embodiments of this invention, the objects/groups are free-format. That is, the display cues can be assigned to any objects/groups in the workspace regardless of their format.

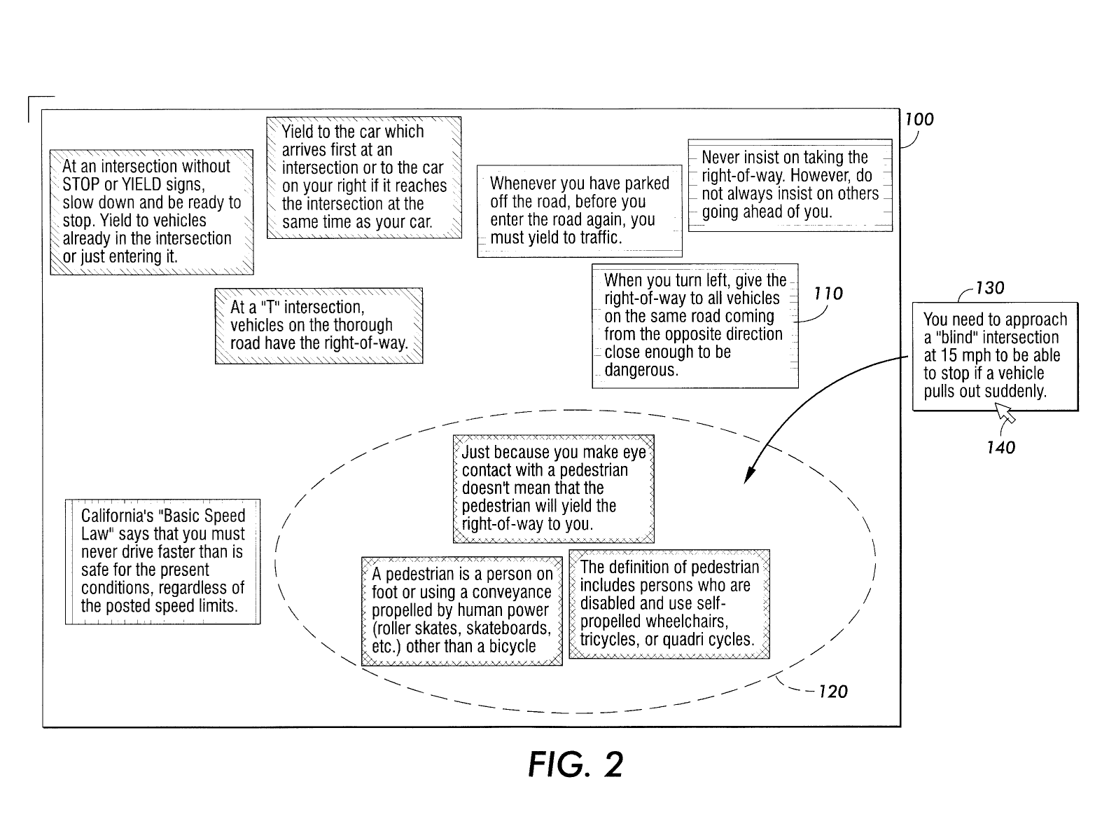

As shown in FIG. 2, according to an embodiment of this invention, when a new object 130 is introduced in the workspace 100, a user may move the new object 130, for example, by dragging the new object 130 using a user input device, such as a mouse (not shown), or by cutting/copying the object 130 and pasting the object 130 at a desired location. A mouse pointer 140 indicates the control of the mouse. The user may freely move the new object 130 in the workspace 100 using a known or hereafter developed technique.

If the new object 130 is moved within a predetermined distance of another object 110 or group 120, the new object 130 is first temporarily assigned the same display cue as that object (or group). The predetermined distance may be, for example, a predetermined number of pixels from the nearest object of the group to the new object, a predetermined distance from the center of each object in the group, a predetermined distance from the center of the group, or a predetermined distance from the group's membership display cues. If the user decides to place the new object 130 while it is temporarily assigned a display cue, such assignment is maintained for the new object 130. At this time, the new object 130 is grouped with the other object 110 or group 120. This enhances recognizability of similarities and common group membership.

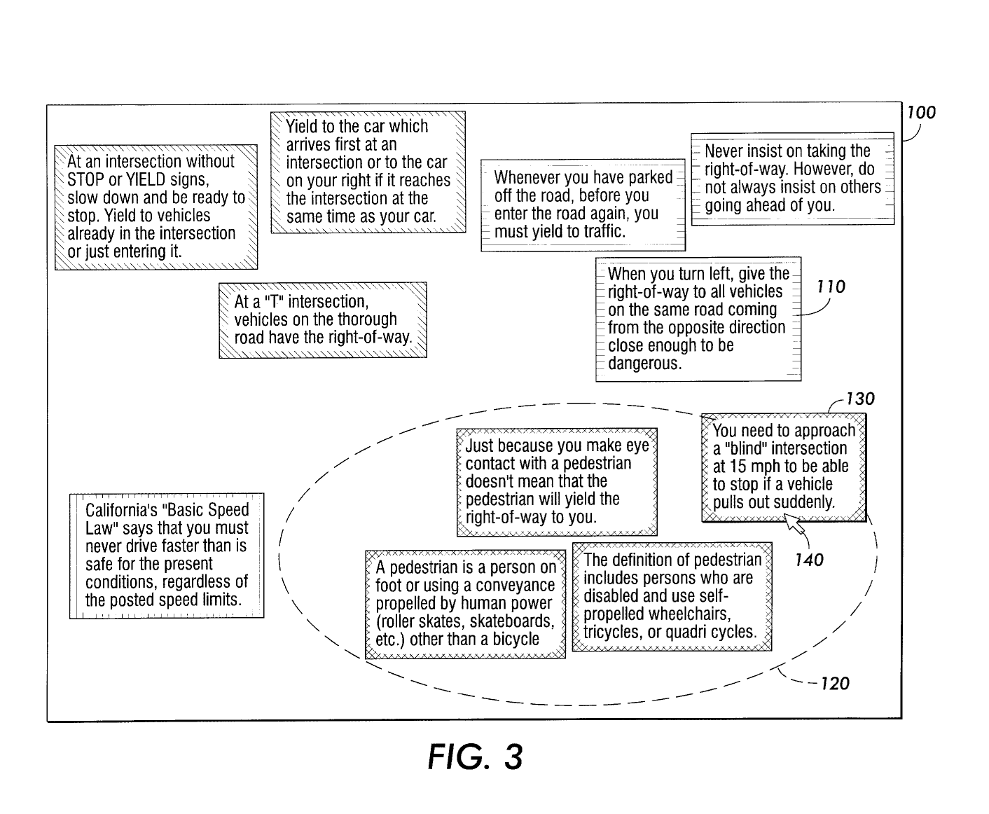

When the user introduces a new object and moves the new object in a workspace, a preview may be provided that shows group membership that will be assigned if the object is dropped at a particular location, as illustrated in FIG. 3. When the user “drops” the new object at a location, the display cue of the object changes based on the display cue assignment, and the object is grouped with the group.

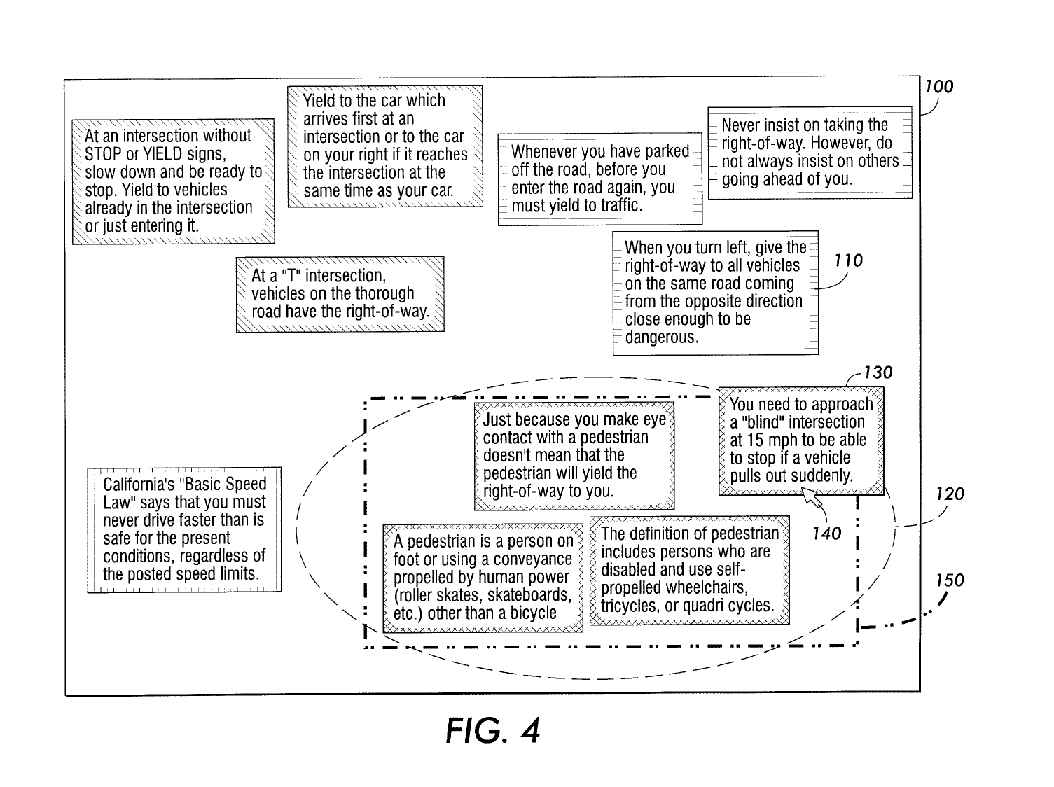

To assist the user's recognition of a group, a boundary 150 of a group 120 may be indicated to show an area in which the object 130 may be dropped and be assigned the display cue 120 of the group, for example, as shown in FIG. 4. Such an indication may include highlighting the boundary 150 of the group 120 and/or blinking the boundary 150 of the group 120. The indication may disappear if the object 130 is dropped or moved beyond the predetermined distance away from the group 120. The shape of the highlighted boundary 150 may be rectangular, as shown, or any other suitable shape, such as circular or polygonal.

If the new object 130 is moved to an area where the new object 130 is not within a predetermined distance from any other object in the workspace 100 and dropped, a new single-item group may be formed, and may be assigned a display cue. The display cue of the new single-item group may be different from the display cues of its nearest neighboring groups to avoid confusion, enhancing recognizability of differences between objects and membership in different groups.

Alternatively, if the new object 130 is moved to an area where the new object 130 is not within a predetermined distance of the other object in the workspace 100, the new object 130 may be identified as “unassigned” and provided with no assignment of display cues or association with any groups. The background color of an unassigned object may be white, for example.

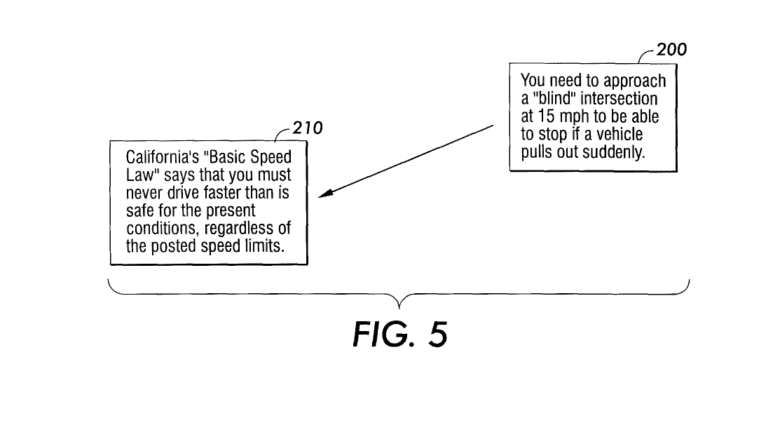

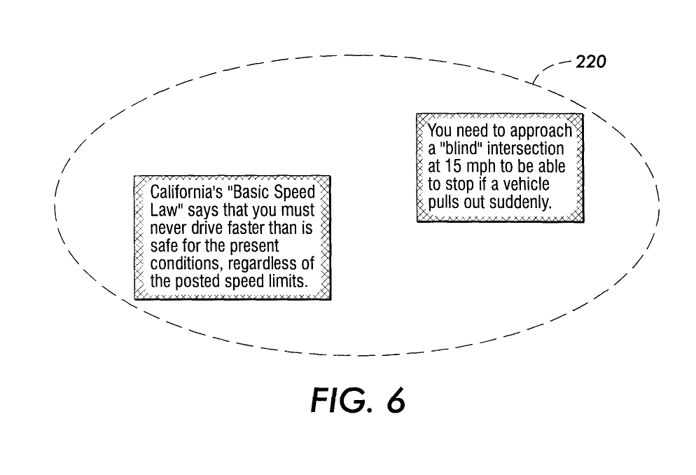

As shown in FIG. 5, when the new/moved object 200 is moved to within a predetermined distance of an unassigned object 210 and dropped, both the new/moved object 200 and the unassigned object 210 may be assigned the same display cue and form a group 220 as shown in FIG. 6. The display cue for the newly formed group 220 may be different from the display cues of neighboring groups.

The above description was made with reference to a new object. However, the description equally applies for an object that already exists in the workspace and is moved from one location to another. In order to move an existing object, the user may move the mouse pointer onto an object, drag the object to a desired location, and drop the object at the desired location, for example. It is also possible to temporarily remove the object to be moved and store it in a temporary storage place, such as a memory or clipboard, and then restore the object at a desired location.

When the user moves an object that is already a member of a group, the user may first select the object by, for example, clicking on the object. If the selected object is moved beyond the predetermined distance away from the group, the display cue of the group is no longer assigned to the selected object. Then, as the user drags the selected object to a desired location, a new display cue may be assigned depending on the distance of the selected object from other objects in the workspace. When the user drops the selected object, the selected object is assigned a new display cue. If the selected object is not moved within a predetermined distance from any other object, the selected object may be assigned a display cue that is different from the neighboring groups or may not be assigned any display cue and indicated as unassigned.

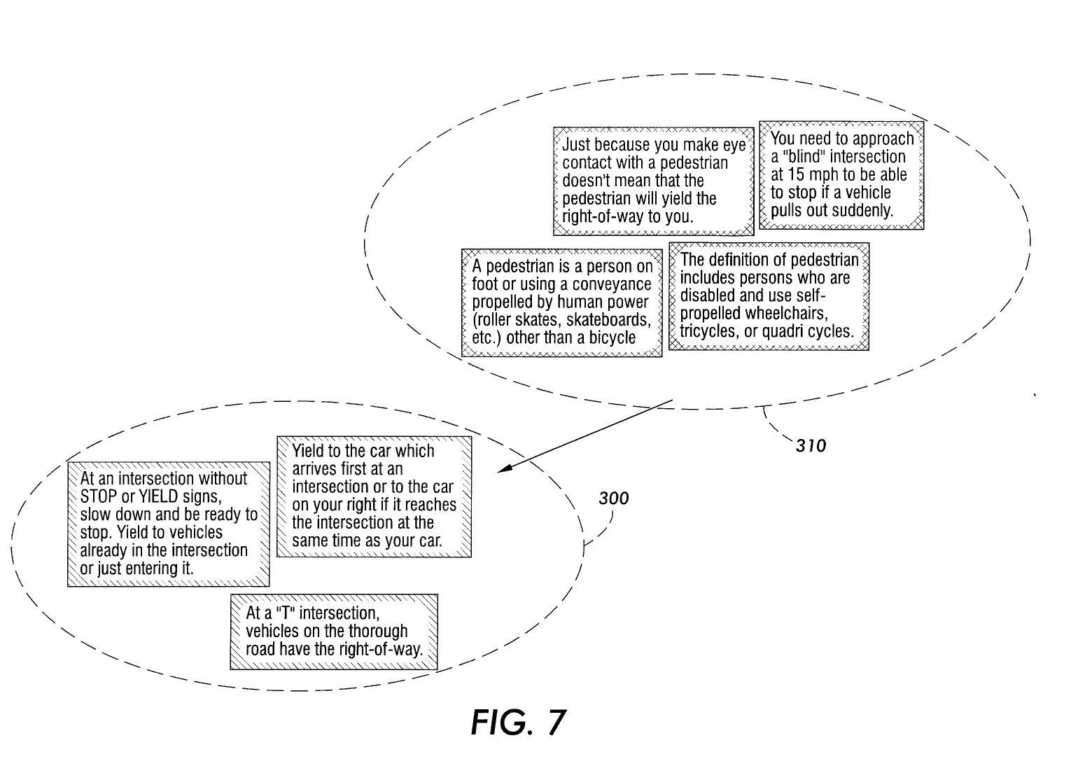

The user may also desire to move an entire group of objects. The user may first select the objects in the group by any suitable known or later-developed technique such as, for example, selecting the plurality of objects that form the group. The user then moves the selected objects. However, unlike moving a single object out of a group, if all objects in the group are selected and moved, the display cue assigned to the group may be maintained since the relationship among the objects in the group may be maintained, thereby enhancing recognizability. As shown in FIG. 7, if only some of the objects 300 are selected and moved beyond the predetermined distance from the other objects 310 of the group, the moved objects may be assigned a display cue different from the display cue of the remaining, unselected objects.

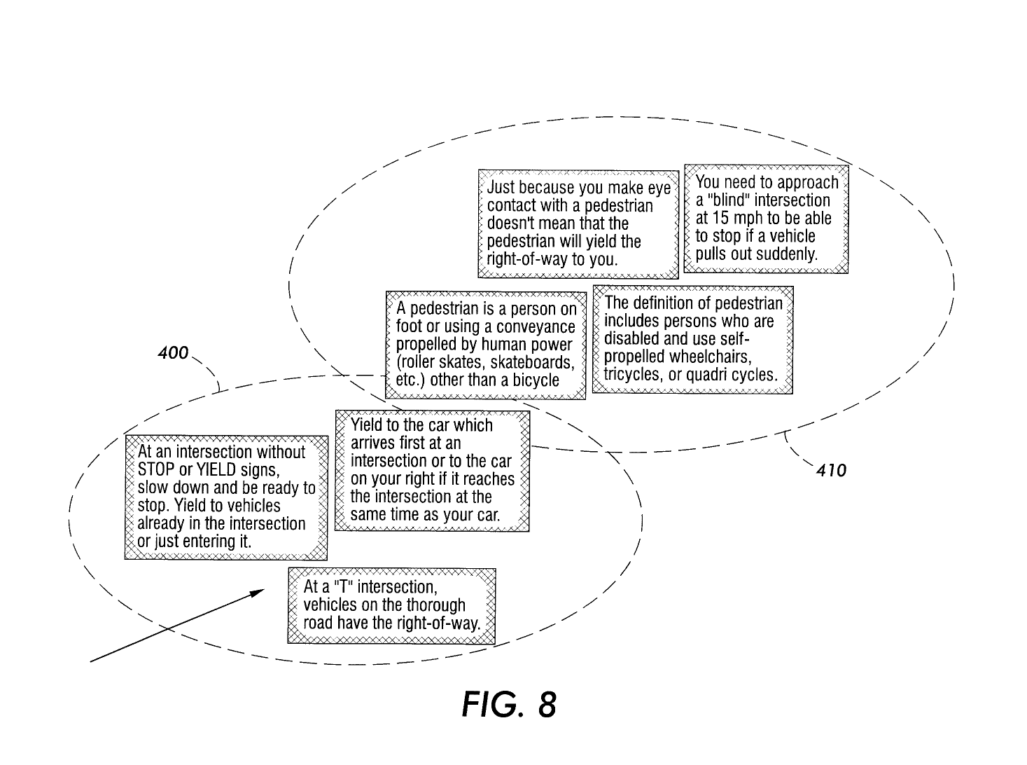

If the user drops the selected group at a desired location within a predetermined distance of another object or group, the display cues assigned to the moved group and the other object or group may remain unchanged unless the moved group is merged with the other object or group to form a single group. If the user wishes to merge the moved group 400 with the other object or group 410 as shown in FIG. 8, the display cue of the larger group (e.g., the group with more objects) may be assigned to the merged group. If the groups are the same size (e.g., the number of objects in each of the groups is the same), the display cue of the other object or group may be assigned to the merged group.

If an object is moved and placed in a group such that the moved object is on top of an existing object of the group, the objects may bump each other so that no objects of the group overlap each other. The bumping may be performed by any suitable known or later developed technique, such as, for example, the techniques disclosed in the incorporated U.S. patent application Ser. No. 10/369,624. However, to avoid bumping, the moved object may be placed at a location within the group that is sufficient to accommodate the moved object or may be placed at an edge of the group.

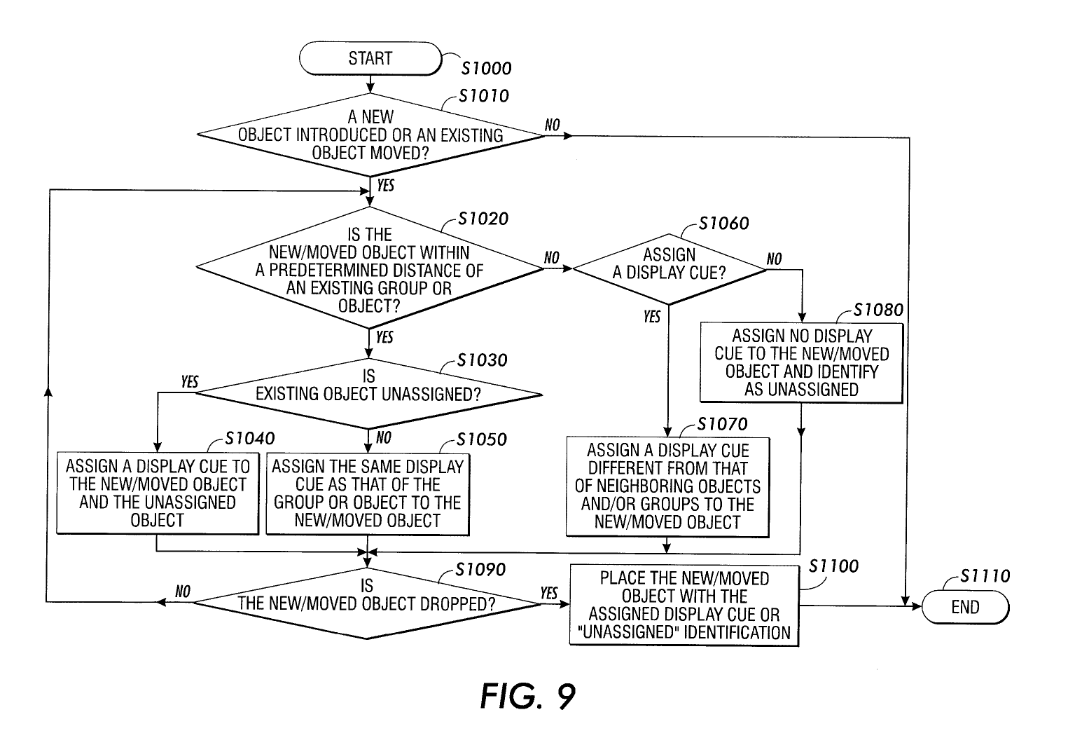

FIG. 9 shows a flowchart outlining an exemplary embodiment of a method of assigning a display cue, such as a background color, to a new or moved object according to this invention.

The process starts at step S1000 and control continues to step S1010. In step S1010, a determination is made whether a new object is introduced or an existing object is moved. If so, control proceeds to step S1020; otherwise, control jumps to step S1130 and ends.

In step S1020, a determination is made whether the new/moved object is moved to within a predetermined distance of an existing group or object. If so, control proceeds to step S1030; otherwise, control jumps to step S1060.

In step S1030, a determination is made whether the existing object, near which the new/moved object is moved, is unassigned. If so, control proceeds to step S1040; otherwise, control jumps to step S1050.

In step S1040, the new/moved object and the unassigned object are assigned a display cue different from the display cues of neighboring objects and/or groups. Then, control jumps to step S1090.

In step S1050, the new/moved object is assigned the display cue of the existing object or group near which the new/moved object is moved. Then, control jumps to step S1090.

In step S1060, a determination is made whether a display cue is to be assigned to the new/moved object. If so, control continues to step S1070; otherwise, control jumps to S1080.

In step S1070, the new/moved object is assigned a display cue different from that of neighboring objects and/or groups. Control then jumps to step S1090.

In step S1080, the new/moved object is not assigned a display cue and is identified as unassigned. Control then continues to step S1090.

In step S1090, a determination is made whether the new/moved object is dropped. If so, control continues to step S1100; otherwise, control returns to step S1020.

In step S1100, the new/moved object is placed with the assigned display cue or the “unassigned” identification. Control then continues to step S1110, where the process ends.

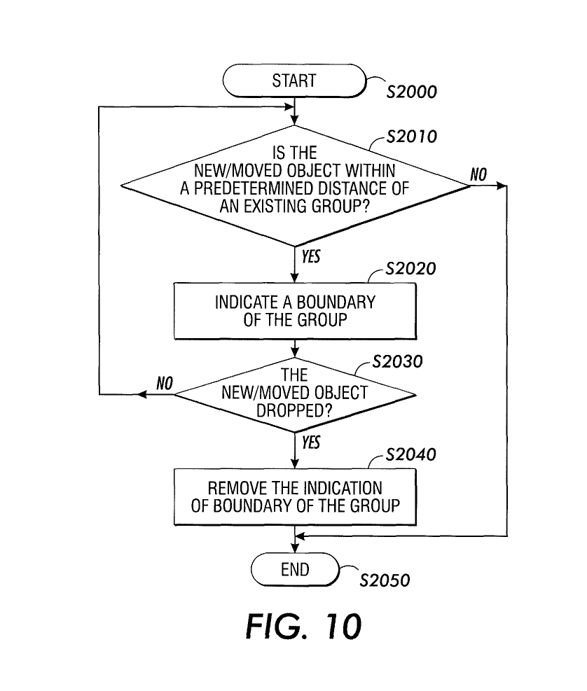

FIG. 10 is a flowchart outlining an exemplary embodiment of a method of presenting an indication of a group boundary according to this invention.

The process starts at S2000 and control continues to step S2010. In step S2010, a determination is made whether the new/moved object is within a predetermined distance of an existing group. If so, control continues to step S2020; otherwise, control jumps to step S2060, where the process ends.

In step S2020, a boundary around the group is indicated. The indication of the boundary may be by highlighting or blinking.

Control then continues to step S2030. In step S2030, a determination is made whether the new/moved object is dropped. If so, control proceeds to step S2040; otherwise, control returns to step S2010.

In step S2040, the indication of the boundary is removed. Control then continues to step S2050, where the process ends.

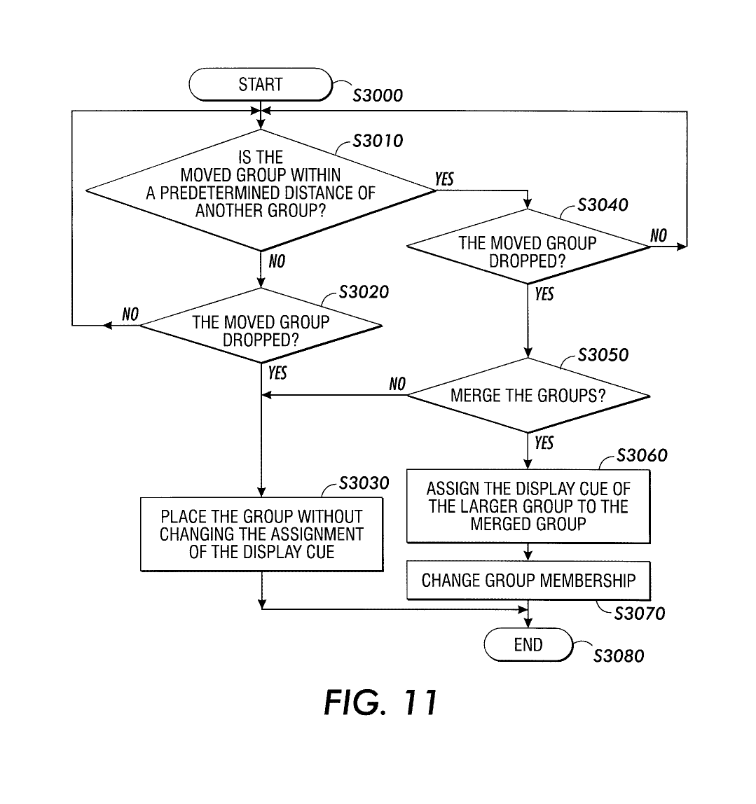

FIG. 11 is a flowchart outlining an exemplary method for assigning display cues according to this invention when a group is moved to a different location.

The process starts at S3000 and control continues to step S3010. In step S3010, a determination is made whether the moved group is within a predetermined distance of another group. If not, control jumps to step S3020.

In step S3020, a determination is made whether the moved group is dropped. If so, control proceeds to step S3030; otherwise, control returns to step S3010. In step S3030, the group is placed in the workspace without changing its assigned display cue. Control then jumps to step S3080, where the process ends.

In step S3040, a determination is made whether the moved group is dropped. If so, control proceeds to step S3050; otherwise, control returns to step S3010.

In step S3050, a determination is made whether the moved group is to be merged with the other group. If so, the control proceeds to step S3060; otherwise, control jumps to step S3030.

In step S3060, the display cue of the larger group is assigned to the smaller group. Control then continues to step S3070.

In step S3070, group membership is changed such that the two groups are recognized as one group. Control then proceeds to step S3080, where the process ends.

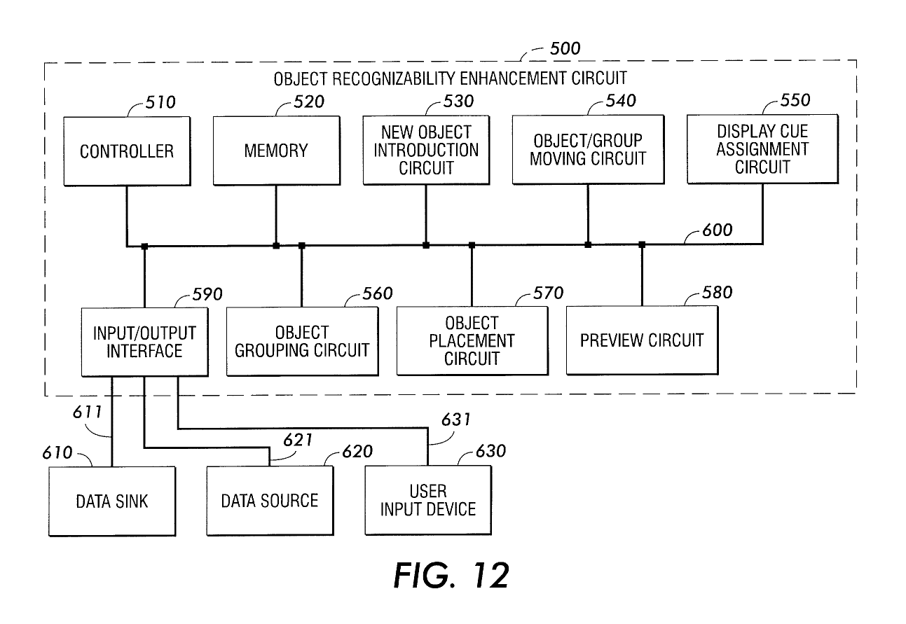

FIG. 12 shows a block diagram of an object recognizability enhancement system 500 according to an exemplary embodiment of this invention. The object recognizability enhancement system 500 includes a controller 510, a memory 520, a new object introduction application, circuit or routine 530, an object/group moving application, circuit or routine 540, a display cue assignment application, circuit or routine 550, an object grouping application, circuit or routine 560, an object placement application, circuit or routine 570, a preview application, circuit or routine 580 and an input/output (I/O) interface 590, which are connected to each other by a communication link 600. A data sink 610, a data source 620 and a user input device 630 are connected to the I/O interface 590 via communication links 611, 621 and 631, respectively.

The controller 510 controls the general data flow between other components of the object recognizability enhancement system 500. The memory 520 may serve as a buffer for information coming into or going out of the system 500, may store any necessary programs and/or data for implementing the functions of the system 500, and/or may store data, such as history data of interactions, at various stages of processing.

Alterable portions of the memory 520 may be, in various exemplary embodiments, implemented using static or dynamic RAM. However, the memory 520 can also be implemented using a floppy disk and disk drive, a writable or rewritable optical disk and disk drive, a hard drive, flash memory or the like.

The new object introduction application, circuit or routine 530 creates a new object or otherwise allows a user to introduce a new object. The new object may be created based on a user's instruction. To provide the instruction, the user may use any known or later developed technique, such as cut/copy-and-paste or dragging techniques, to introduce a new object. Using such know or later developed techniques, a mouse pointer may represent the object while the object may be temporarily removed from the workspace and stored in a temporarily stored in the memory 520, for example, until the user instructs the placement of the object.

The object/group moving application, circuit or routine 540 allows the user to move an object or a group that exists in a workspace. To move the object or group, the user may select the desired object or group by, for example, clicking on the object or blocking the objects in the group. The user then can move the object or group by any known or later developed techniques, such as cut-copy-and-paste or dragging techniques, for example.

The display cue assignment application, circuit or routine 550 determines whether the new/moved object is moved to within a predetermined distance of another object or group and assigns a display cue to the new/moved object based on its location relative to other objects and/or groups. When the new/moved object is moved within a predetermined distance from another object or group, the display cue of the other object or group is assigned to the new/moved object. If the new/moved object is not placed within a predetermined distance of any of the existing objects/groups in the workspace, the display cue assignment application, circuit or routine 550 may assign the new/moved object a display cue that is not used by the nearest objects and/or groups to, or may identify the new/moved object as “unassigned” and not assign any display cue to the new/moved object.

If the new/moved object is moved to within a predetermined distance of an unassigned object, a display cue that is different from that of the nearest objects and/or groups may be assigned to both the new/moved object and the unassigned object, thus forming a new group. In addition, when an object is moved beyond the predetermined distance away from a group to which the object had belonged, the display cue assignment application, circuit or routine 550 removes the assigned display cue and treats the moved object in the manner described above.

The object grouping application, circuit or routine 560 forms groups of objects in a workspace. When the new/moved object is placed within a predetermined distance of an existing object or group, the object grouping application, circuit or routine 560 makes the new/moved object a member of the existing group or forms a new group as described above. When a group having more than one object is moved to within a predetermined distance of another group, the object grouping application, circuit or routine 560 may ask the user whether the two groups should be merged. If so, the object grouping application, circuit or routine 560 merges the two groups and forms a single group.

The object placement application, circuit or routine 570 places a new object or moved object/group at a current spatial location when the user's instruction of placement is received. The instruction may be, for example, releasing the mouse button (dropping technique) or tasting from the memory 540 at a desired location.

When an object is temporarily moved, i.e., before the object is placed, to within a predetermined distance of another object/group, the preview application, circuit or routine 580 may temporarily show a preview of the display cue to be assigned to the object based on the other object/group. The preview application, circuit or routine 580 may indicate the boundary of the group, for example, by highlighting the boundary. If the other object close to which the object is moved is an unassigned object, the preview application, circuit or routine 590 may show a preview of the unassigned object and the moved object forming a new group. The preview may be canceled when the object is moved beyond the predetermined distance away from the other object/group.

The I/O interface 590 provides a connection between the object recognizability enhancement system 500 and the data sink 610, the data source 620, and the user input device 630, via the communication links 611, 621, and 631, respectively.

The data sink 610 can be any known or later-developed device that is capable of outputting or storing the processed media data generated using the systems and methods according to the invention, such as a display device, a printer, a copier or other image forming device, a facsimile device, a memory or the like. In exemplary embodiments, the data sink 610 is assumed to be a display device, such as a computer monitor or the like, and is connected to the object recognizability enhancement system 500 over the communication link 611.

The data source 620 can be a locally or remotely located computer sharing data, a scanner, or any other known or later-developed device that is capable of generating electronic media, such as a document. The data source 620 may also be a data carrier, such as a magnetic storage disc, CD-ROM or the like. Similarly, the data source 620 can be any suitable device that stores and/or transmits electronic media data, such as a client or a server of a network, or the Internet, and especially the World Wide Web, and news groups. The data source 620 may also be any known or later developed device that broadcasts media data.

The electronic media data of the data source 620 may be text, a scanned image of a physical document, media data created electronically using any software, such as word processing software, or media data created using any known or later developed programming language and/or computer software program, the contents of an application window on a sensemaker's desktop, e.g., the toolbars, windows decorations, a spreadsheet shown in a spreadsheet program, or any other known or later-developed data source.

The user input device 630 may be any known or later-developed device that is capable of imputing data and/or control commands to the interactive classification system 500 via the communication link 631. The user input device may include one or more of a keyboard, a mouse, a touch pen, a touch pad, a pointing device, or the like.

The communication links 600, 611, 621 and 631 can each be any known or later-developed device or system for connecting between the controller 510, the memory 520, the new object introduction application, circuit or routine 530, the object/group moving application, circuit or routine 540, the display cue assignment application, circuit or routine 550, the object grouping application, circuit or routine 560, the object preview application, circuit or routine 580 and the I/O interface 590, to the data sink 610, the data source 620, and the user input device 630, respectively, to the object recognizability enhancement system 500, including a direct cable connection, a connection over a wide area network or local area network, a connection over an intranet, a connection over the Internet, or a connection over any other distributed processing network system. Further, it should be appreciated that the communication links 600, 611, 621 and 631 can be, a wired wireless or optical connection to a network. The network can be a local area network, a wide area network, an intranet, the Internet, or any other known or later-developed other distributed processing and storage network.

In the exemplary embodiments outlined above, the object recognizability enhancement system 500 can be implemented using a programmed general-purpose computer. However, the object reconcilability enhancement system 500 can also be implemented using a special purpose computer, a programmed microprocessor or microcontroller and peripheral integrated circuit elements, an ASIC or other integrated circuit, a digital signal processor, a hardware electronic or logic circuit, such as a discrete element circuit, a programmable logic device, such as PLD, PLA, FPGA or PAL, or the like. In general, any device, capable of implementing a finite state machine that is in turn capable of implementing the flowchart shown in FIGS. 9-11 can be used to implement the object recognizability enhancement system 500.

Each of the circuits or routines and elements of the various exemplary embodiments of the object recognizability enhancement system 500 outlined above can be implemented as portions of a suitable programmed general purpose computer. Alternatively, each of the circuits and elements of the various exemplary embodiments of the object recognizability enhancement system 500 outlined above can be implemented as physically distinct hardware circuits within an ASIC, or using FPGA, a PDL, a PLA or a PAL, or using discrete logic elements or discrete circuit elements. The particular form each of the circuits and elements of the various exemplary embodiments of the object recognizability enhancement system 500 outlined above will take is a design choice and will be obvious and predicable to those skilled in the art.

Moreover, the exemplary embodiments of the object recognizability enhancement system 500 outlined above and/or each of the various circuits and elements discussed above can each be implemented as software routines, managers or objects executing on a programmed general purpose computer, a special purpose computer, a microprocessor or the like. In this case, the various exemplary embodiments of the object recognizability enhancement system 500 and/or each or the various circuits and elements discussed above can each be implemented as one or more routines embedded in the communication network, as a resource residing on a server, or the like. The various exemplary embodiments of the object recognizability enhancement system 500 and the various circuits and elements discussed above can also be implemented by physically incorporating the object recognizability enhancement system 500 into a software and/or hardware system, such as the hardware and software system of a web server or a client device.

It is apparent that the steps shown in FIGS. 9-11 are described for illustration purposes, and in various exemplary embodiments, the various steps described above, may be performed in a different order and/or with additional or fewer steps. Furthermore, this invention is not limited to the above described flowcharts.

Additionally, those skilled in the art will recognize many applications for this invention include, but not limited to, document display devices, such as browser devices, that display applications of a personal computer, handheld devices, and the like. In short, this invention has application to any known or later-developed systems and devices capable of interactively classifying objects in a workspace.

While this invention has been described in conjunction with the exemplary embodiments outlined above, it is evident that many alternatives, modifications and variations will be apparent to those skilled in the art. Accordingly, the exemplary embodiments of this invention, as set forth above, are intended to be illustrative, not limiting. Various changes may be made without departing from the spirit and scope of this invention.

1. A method for enhancing recognizability of objects/groups in a workspace, comprising:
determining whether a first object/group is moved to a location within a predetermined distance of a second object/group; and
assigning a display cue of the second object/group to the first object/group upon placement of the first object/group in the workspace, whereby the first object/group and the second object/group form a group.

2. The method of claim 1, wherein the objects/groups are free-format.

3. The method of claim 1, wherein the display cue includes at least one of group-specific background color for objects/groups, group-specific color for text of objects/groups, group-specific color for bounding lines for objects/groups, colored halos or containers for objects/groups, colored regions surrounding objects/groups, line pattern boundaries for objects/groups, unique halftone or gray-shade boundaries for objects/groups, common font for text of objects/groups, and title bars.

4. The method of claim 1, further comprising temporarily assigning the display cue of the second object/group to the first object/group when the first object/group is moved to a location within the predetermined distance of the second object/group.

5. The method of claim 1, further comprising:
determining whether the second object/group has an assigned display cue; and
when the second object/group is determined not to have an assigned display cue, assigning another display cue that is different from a display cue of neighboring objects/groups

6. The method of claim 1, further comprising when the first object/group is determined not to be within the predetermined distance of the second object/group, identifying the first object/group as unassigned.

7. The method of claim 1, wherein the first object/group is a new object.

8. The method of claim 1, wherein the first object/group is an existing object/group being moved from another location in the workspace.

9. The method of claim 1, wherein the predetermined distance is at least one of a distance from the closest object in the second object/group, a distance from the center of the second object/group, and a distance from group membership display cues.

10. The method of claim 1, further comprising providing a boundary of the second object/group when the first object/group is within the predetermined distance.

11. The method of claim 10, wherein the boundary is at least one of rectangular, circular and polygonal.

12. The method of claim 1, further comprising assigning a new display cue to the first object/group and the second object/group upon placement of the first object/group at the location, when the second object/group is determined not to have an assigned display cue, whereby the first object/group and the second object/group form a new group.

13. The method of claim 1, further comprising:
providing an option not to assign the display cue to the first object/group; and
maintaining an original assignment of a display cue of the first object/group.

14. A system that enhances recognizability of objects/groups in a workspace, comprising:
a display cue assignment circuit that determines whether a first object/group is moved to a location within a predetermined distance of a second object/group, and assigns a display cue of the second object/group to the first object/group upon placement of the first object/group at the location;
an object placement circuit that places the at least one first object at a the location; and
an object grouping circuit that groups the first object/group and the second object/group when the first object/group is assigned the display cue of the second object/group.

15. The system of claim 14, wherein the objects/groups are free-format.

16. The system of claim 14, wherein the display cue includes at least one of group-specific background color for objects/groups, group-specific color for text of objects/groups, group-specific color for bounding lines for objects/groups, colored halos or containers for objects/groups, colored regions surrounding objects/groups, line pattern boundaries for objects/groups, unique halftone or gray-shade boundaries for objects/groups, common font for text of objects/groups, and title bars.

17. The system of claim 14, wherein the display cue assignment circuit temporarily assigns the display cue of the second object/group to the first object/group when the first object/group is moved to a location within the predetermined distance of the second object/group.

18. The system of claim 14, wherein the display cue assignment circuit determines whether the second object/group has an assigned display cue, and when the second object/group is determined not to have an assigned display cue, assigns another display cue that is different from a display cue of neighboring objects/groups

19. The system of claim 14, wherein when the display cue assignment circuit determines that the first objects/groups is not within the predetermined distance of the second object/group, the display cue assignment circuit identifies the first object/group as unassigned.

20. The system of claim 14, wherein the first object/group is a new object.

21. The system of claim 14, wherein the first object/group is an existing object/group being moved from another location in the workspace.

22. The system of claim 14, wherein the predetermined distance is at least one of a distance from the closest object in the second object/group, a distance from the center of the second object/group, and a distance from group membership display cues.

23. The system of claim 14, further comprising a preview circuit that provides a boundary of the second object/group when the first object/group is within the predetermined distance.

24. The system of claim 23, wherein the boundary is at least one of rectangular, circular and polygonal.

25. The system of claim 14, wherein the display cue assignment circuit assigns a new display cue to the first object/group and the second object/group upon placement of the first object/group at the location, when the second object/group is determined not to have an assigned display cue, whereby the object grouping circuit groups the first object/group and the second object/group.

26. The system of claim 14, wherein the object grouping circuit provides an option not to assign the display cue to the first object/group, and the display cue assignment circuit maintains an original assignment of a display cue of the first object/group.

27. A computer readable storage medium comprising:
computer readable program code embodied on the computer readable storage medium, the computer readable program code usable to program a computer to program a method for enhancing recognizability of objects/groups in a workspace, the method comprising:
determining whether a first object/group is moved to a location within a predetermined distance of a second object/group; and
assigning a display cue of the second object/group to the first object/group upon placement of the first object/group in the workspace, whereby the first object/group and the second object/group form a group.

28. The computer readable storage medium of claim 27, wherein the objects/groups are free-format.

29. The computer readable storage medium of claim 27, wherein the display cue includes at least one of group-specific background color for objects/groups, group-specific color for text of objects/groups, group-specific color for bounding lines for objects/groups, colored halos or containers for objects/groups, colored regions surrounding objects/groups, line pattern boundaries for objects/groups, unique halftone or gray-shade boundaries for objects/groups, common font for text of objects/groups, and title bars.

30. The computer readable storage medium of claim 27, further comprising temporarily assigning the display cue of the second object/group to the first object/group when the first object/group is moved to a location within the predetermined distance of the second object/group.

31. The computer readable storage medium of claim 27, wherein the method further comprises:
determining whether the second object/group has an assigned display cue; and
when the second object/group determined not to have an assigned display cue, assigning another display cue that is different from a display cue of neighboring objects/groups

32. The computer readable storage medium of claim 27, wherein the method further comprises when that the first objects/groups is determined not to be within the predetermined distance of the second object/group, identifying the first object/group as unassigned.

33. The computer readable storage medium of claim 27, wherein the first object/group is a new object.

34. The computer readable storage medium of claim 27, wherein the first object/group is an existing object/group being moved from another location in the workspace.

35. The computer readable storage medium of claim 27, wherein the predetermined distance is at least one of a distance from the closest object in the second object/group, a distance from the center of the second object/group, and a distance from group membership display cues.

36. The computer readable storage medium of claim 27, wherein the method further comprises providing a boundary of the second object/group when the first object/group is within the predetermined distance.

37. The computer readable storage medium of claim 27, wherein the boundary is at least one of rectangular, circular and polygonal.

38. The computer readable storage medium of claim 27, wherein the method further comprises assigning a new display cue to the first object/group and the second object/group upon placement of the first object/group at the location, when the second object/group is determined not to have an assigned display cue, whereby the first object/group and the second object/group form a new group.

39. The computer readable storage medium of claim 27, wherein the method further comprises:
providing an option not to assign the display cue to the first object/group; and
maintaining an original assignment of a display cue of the first object/group.

40. A carrier wave encoded to transmit a control program usable for enhancing recognizability of objects/groups in a workspace, wherein the objects/groups are free-format, the control program comprising:
instructions for determining whether a first object/group is moved to a location within a predetermined distance of a second object/group; and
instructions for assigning a display cue of the second object/group to the first object/group upon placement of the first object/group in the workspace, whereby the first object/group and the second object/group form a group.
